(19) United States
(12) Patent Application Publication
(10) Pub. No.: US 2007/0248735 A1
(43) Pub. Date: Oct. 25, 2007

(54) JUICES INCORPORATING MID-SEASON ORANGE CULTIVARS

(75) Inventors: James H. Keithly, Bradenton, FL (US); Thomas Taggart, Bradenton, FL (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: TROPICANA PRODUCTS, INC., Bradenton, FL (US)

(21) Appl. No.: 11/743,064

(22) Filed: May 1, 2007

Related U.S. Application Data
(63) Continuation of application No. 10/650,291, filed on Aug. 28, 2003, now abandoned.
Application No. 10/650,291 is a continuation of application No. 09/583,334, filed on May 31, 2000, now abandoned.
Application No. 09/583,334 is a continuation-in-part of application No. 09/545,397, filed on Apr. 7, 2000, now abandoned.
Application No. 09/545,397 is a continuation-in-part of application No. 09/311,956, filed on May 14, 1999, now Pat. No. 6,143,347.

(51) Int. Cl. A23L 2/02

(52) U.S. Cl. 426/590

(57) ABSTRACT

Orange juice products are provided which include as a component juice extracted from a mid-season round orange cultivar having a peak harvest season in December, January and February. The preferred mid-season round orange cultivar is the Vernia cultivar. The juice extracted from such mid-season cultivar has sensory attributes which are superior to those of traditional late season Valencia round orange cultivar juice. The mid-season juice has a Brix-to-acid ratio and a color intensity at least as high as juice provided by the traditional Valencia cultivars which are harvested at the same time as the mid-season cultivar.

### CROSS REFERENCE TO RELATED APPLICATION

This application is a continuation of Ser. No. 10/650,291, filed Aug. 28, 2003, which is a continuation of application Ser. No. 09/583,334, filed May 31, 2000, now abandoned, which is a continuation-in-part of application Ser. No. 09/545,397, filed Apr. 7, 2000, now abandoned, which is a continuation-in-part of application Ser. No. 09/311,956, filed May 14, 1999, now U.S. Pat. No. 6,143,347, issued Nov. 7, 2000.

### BACKGROUND OF THE INVENTION

This invention generally relates to juices which are prepared from orange juice sources that incorporate juices from certain so-called mid-season orange tree cultivars which have been discovered to exhibit improvements over traditional round oranges used in preparing juices which are harvested in the middle of the round orange growing season. This harvesting time is from December to February in the Northern Hemisphere. Included are 100% juices, including those which have not been subjected to procedures which concentrate the juice. In the citrus industry, these types of juice products are known as being “not from concentrate” juices.

More particularly, the invention relates to improved mid-season originating juices which consistently exhibit important sensory improvements and chemical properties improvements over 100% juice products harvested at the same time from other orange juice sources. They also exhibit advantageously high Color Number values. These enhancements are particularly valuable due to their being provided by fresh juice sources according to the invention during the time period which is between the peak season for early-to-mid season maturing round orange cultivars and the peak season for late season maturing round orange cultivars.

When considering the not from concentrate orange juice industry, a persistent problem is the maintenance of superior sensory attributes and a consistent, deep rich orange color throughout the year. This is recognized as a problem during the early fruit-harvesting season of orange trees. It will be appreciated that different varieties or cultivars of orange trees bear harvest-ready fruit at somewhat different times within the overall citrus growing season. In the Northern Hemisphere, traditionally the overall citrus growing season extends between approximately October and June. Generally speaking, Valencia round oranges can be considered to provide a bench mark for orange juice quality, both with respect to analytical properties and sensory properties. Many not from concentrate juices are a blend of freshly squeezed juice with stored juice, which can be stored Valencia juice, for example. Valencia cultivars tend to have a growing season which is in a later portion of the overall round orange harvest season. A typical Valencia season runs between about February and June. Other round oranges such as Hamlin oranges are early season harvested for freshly squeezed orange juice, such as during approximately the months of October, November and December. Certain orange cultivars such as Pineapple oranges have a mid-to-later-season harvest characteristic, running between about December and March.

In the not from concentrate juice industry, these important properties of juice sensory, chemical and color characteristics are inferior when the Valencia oranges are early in their harvest season. At present, the principal early season variety is the Hamlin variety. One of the drawbacks of Hamlin round oranges is that a Hamlin round orange crop does not, in general, meet all of the quality standards of Valencia round oranges. Likewise, the currently used mid-season round orange cultivars do not meet all of the quality standards of peak season Valencia round oranges. Some of these quality standards relate to sensory attributes; others relate to chemical analyses and to color.

Sensory attributes include data which can relate to sweetness/tartness balance, strength of orange flavor, and the like, as well as other sensory detectible components. Sensory attributes can be gauged by recognized testing procedures, typically of a type which rely upon the detection of specific sensory components by trained panels. Tabulations of the responses of the panelists provide flavor and sensory profile results which quantify the sensory characteristics of the juices. These results allow a generally objective evaluation of important sensory components such as green character, bitterness, chemical notes, raw flavors, total orange flavors, and the like.

Important chemical analysis standards include total minimum solids percentage (or Brix), citric acid content, and Brix to acid ratio (or BAR). Other analysis parameters include percentage of oil and percentage of vitamin C. Chemical analyses have long been used in the citrus industry to gauge characteristics of the chemical make-up of a fruit or juice. It will be appreciated that each of these characteristics is well understood in the fruit and produce industries, and especially within the citrus fruit and commercial juice industry. They long have been one of the important components in judging the quality of fruit. For example, a Brix difference of 0.8. degree. is detectible, from a sensory point of view, when comparing different orange juice products.

Color is a property of juices which can be measured in an objective manner for purposes of evaluating the color acceptability of a particular type of juice. In the case of citrus juices, the industry generally recognizes a parameter referred to as Color Number. Details of color determination, including procedures, equipment and standards, are found in Redd, Hendrix and Hendrix, Quality Control Manual for Citrus Processing Plants, Volume 1: Regulation, Citrus Methodology, Microbiology, Conversion Charts, Tables, Other; 1986; Intercit., Inc., Safety Harbor, Fla. A calorimeter is a primary component of the Color Number determination procedure. Redd et al provides specific calibration information for a variety of such instruments, including HunterLab Model D45, HunterLab Model D45D2, HunterLab LabScan Colorimeter Model LS-5100, MacBeth Color-Eye Colorimeter Model 1500 and Minolta Portable Colorimeter Model Chroma Meter II Reflectants/CR 100.

These objective Color Number data are important components of categorizing single strength orange juice as, for example, Grade A or Grade B juice. A Grade B orange juice has a Color Number of between 32 and 35 CN units. A Grade A orange juice has a Color Number of between 36 and 40 CN units. A high quality not from concentrate orange juice seeks to meet the Grade A standard, although this is not always possible, particularly for the earlier season juices.

In addition, it has come to be appreciated through objective testing that juice color has an important impact on consumer liking of orange juice. Sensory tests which evaluated juice properties concluded that orange juice color intensity is important to consumer acceptance and preference. Generally speaking, consumer liking for orange juice increases as the color becomes darker and more orange. It has been determined that consumers can clearly detect an increase in color of as low as 1 Color Number or Color Value unit. The testing included juices having various Color Numbers, ranging between about 34 CN to about 42 CN. Juices having a higher Color Number in a comparison set were chosen as more desirable. Accordingly, it now has come to be appreciated that color intensity is a very important characteristic of orange juice products in general and of not from concentrate orange juice in particular.

These various characteristics are very important in maintaining or enhancing consumer acceptance of orange juice. These characteristics of sensory profile, chemical analysis standards, and color intensity each are important to evaluating juice quality, Even though color has been found to be very important in consumer acceptance, superior color intensity should not be achieved at the expense of these other characteristics which relate to sensory qualities and chemical analysis standards.

When these factors are considered in connection with mid-season extracted orange juice, it would be extremely valuable to be able to maintain, and better still to improve upon, combined or individual sensory, chemical and color parameters and characteristics for a freshly squeezed juice blend component which is collected after peak harvest time for early season or mid-season round orange fruit, such as Hamlin cultivars and before peak season for late-season round orange cultivars, such as the often used Valencia cultivars including Hughes and Rhode Red cultivars, which are the current industry standards for these types of round orange juice sources. For example, color scores are traditionally low for early season round oranges, particularly Hamlin round oranges. While color now has been determined to be an important component of consumer acceptance of orange juice, color enhancement cannot be achieved at the expense of maintaining the other characteristics of a first-class orange-containing juice, especially not from concentrate orange juice products. It also is important that the color enhancement be achieved without the use of artificial colorants or coloring components which disqualify the orange juice product from falling within the standard of identity of not from concentrate orange juice. Otherwise, color enhancement would seriously negatively impact on the orange juice.

Accordingly, an important need exists for an approach to enhance mid-season juice collections in their sensory and chemical attributes and in their color, especially in not from concentrate orange juice products. These enhancements provide such products with important, tangible and economically valuable benefits when compared with previously available not from concentrate juice products, as well as “from concentrate” orange juice products and the like which are put up during the middle of the round orange harvest season. It is also important that these improvements, including color enhancement, be achieved in a fully natural manner and in a way which is fully consistent with the standard of identity of products such as 100% juices, including not from concentrate orange juices.

Additionally, important advantages would be realized by being able to meet the standards for freshly squeezed orange juice for not from concentrate orange juice during a time period which is earlier than that of the long-accepted standard-of-the-industry cultivars, Valencia round oranges. This would allow an advancement of the date by which freshly squeezed juices impart ideal qualities to mid-season harvested juices and for not from concentrate orange juice, which would benefit the orange juice category. To do so requires that such a freshly squeezed juice source also would be able to maintain or exceed sensory and chemical characteristics of the Valencia ideal, even during such a harvest time period which is earlier than the peak harvest season for the preferred Valencia cultivars.

Accordingly, there is a need for a source for orange juice expressed during the gap between peak times for traditional early-to-mid season juices and for late season Valencia juices. The need ideally could be filled by a juice which is freshly available during the lull between these peak seasons, when overall harvested juice quality heretofore has not been maintained, such as during the late December to early February harvest time period within the Northern Hemisphere.

### SUMMARY OF THE INVENTION

In accordance with the present invention, mid-season not from concentrate orange juice products are provided which have exceptional sensory characteristics, chemical characteristics and color. These mid-season attributes are superior to those of other round oranges when harvested during this mid-season time period. This includes extracting the juice from round orange cultivar fruit that has been discovered to possess a combination of very superior mid-season attributes when compared with round orange cultivars which have been in use heretofore during this in-between harvest time. The cultivar possessing these superior intermediate season juice attributes is the Vernia cultivar, also known as a Verna cultivar or a Berna cultivar. Also suitable in some respects in this regard is the Frost cultivar. The extracted orange juice from at least the Vernia cultivar has been found to improve sensory characteristics, certain important chemical properties, and provide excellent color attributes at least as deep in color as Valencia juices expressed during peak Valencia season. This superior intermediate season juice can be blended with other juice sources. The juices can be of the not from concentrate type and have exceptional sensory characteristics and a color value well within the color standards for Grade A orange juice.

Also included is an orange juice product and method of preparing an orange juice product incorporating the intermediate or mid-season orange cultivar. Such can be of the from concentrate type. This includes harvesting the mid-season orange cultivar during the intermediate season to provide a juice having sensory and chemical properties superior to Valencia orange juice expressed at the same time while also exhibiting at least comparable deep orange color intensity. This intermediate round orange cultivar comprises a Vernia cultivar. Juice is extracted and collected from a volume of these oranges.

When desired, at least about 5 volume percent, based on the total volume of the orange juice product, of said extracted intermediate season orange juice is blended with another orange juice source in order to provide a blended orange juice product. Preferably, this blended juice product is 100% juice and exhibits an enhanced sensory profile and/or a Color Number in excess of 35 Color Number units.

It is a general object of the present invention to provide improved mid-season not from concentrate orange juice.

Another object of this invention is to provide an improved method by which intermediate season not from concentrate orange juice sensory attributes are improved over those provided by other cultivars, including one or more of early-to-mid season and/or later season round orange juice as a freshly squeezed mid-season cultivar of the orange juice product.

Another object of this invention is to provide an improved method by which mid-season not from concentrate orange juice color is improved over that available from using Hamlin round orange juice and/or Valencia round orange juice as a freshly squeezed intermediate season cultivar of the orange juice.

Another object of the present invention is to provide an improved not from concentrate orange juice which has enhanced mid-season sensory characteristics and/or chemical attributes and thus enhanced value.

Another object of the present invention is to provide an improved not from concentrate orange juice which has enhanced mid-season color and thus enhanced value.

Another object of the present invention is to provide an improved intermediate season or very early late season juice source which is suitable for not from concentrate orange juice and which consistently meets governmental crop maturity criteria, such as Brix-to-acid ratio, during the intermediate season before the peak season of the currently used standard Valencia round orange cultivars.

Another object of the invention is to provide mid-harvest season freshly squeezed orange juice which maintains and usually exceeds sensory characteristics of traditional later season freshly squeezed orange juice harvested during the same time period.

Another object of the present invention is to provide an improved orange juice product which has enhanced sensory characteristics and/or chemical attributes and/or enhanced color, and thus enhanced value.

These and other objects, features and advantages of the present invention will be apparent from and clearly understood through a consideration of the following detailed description.

### BRIEF DESCRIPTION OF THE DRAWINGS

In the course of this description, reference will be made to the attached drawings, wherein:

FIG. 1 is a plot of polynomial trend lines of overall quality scores of three different types of cultivars, showing the gap-filling quality attributes of the Vernia cultivar when used in accordance with the invention;

FIG. 2A is plot of sweet sensory notes data and a polynomial analysis of such data for blends including varying levels of Vemia round orange juice with Pineapple round orange cultivar juice;

FIG. 2B is plot of raw orange sensory notes data and a linear analysis of such data for blends including varying levels of Vernia round orange juice with Pineapple round orange cultivar juice;

FIG. 2C is plot of package sensory notes data and a linear analysis of such data for blends including varying levels of Vernia round orange juice with Pineapple round orange cultivar juice;

FIG. 3A is plot of total orange sensory data and a linear analysis of such data for blends including varying levels of Vernia round orange juice with Hughes Valencia round orange cultivar juice;

FIG. 3B is plot of green notes sensory data and a linear analysis of such data for blends including varying levels of Vemia round orange juice with Hughes Valencia round orange cultivar juice;

FIG. 3C is plot of sweet notes sensory data and a linear analysis of such data for blends including varying levels of Vernia round orange juice with Hughes Valencia round orange cultivar juice;

FIG. 3D is a plot of sour notes sensory data and a polynomial analysis of such data for blends including varying levels of Vernia round orange juice with Hughes Valencia round orange cultivar juice;

FIG. 3E is a plot of bitter notes sensory data and a polynomial analysis of such data for blends including varying levels of Vernia round orange juice with Hughes Valencia round orange cultivar juice;

FIG. 3F is a plot of feeling factors sensory data and a polynomial analysis of such data for blends including varying levels of Vernia round orange juice with Hughes Valencia round orange cultivar juice;

FIG. 4A is plot of other citrus notes sensory data and a linear analysis of such data for blends including varying levels of Vernia round orange juice with Rhode Red Valencia round orange cultivar juice;

FIG. 4B is plot of sweet notes sensory data and a linear analysis of such data for blends including varying levels of Vernia round orange juice with Rhode Red Valencia round orange cultivar juice;

FIG. 4C is plot of bitter notes sensory data and a polynomial analysis of such data for blends including varying levels of Vernia round orange juice with Rhode Red Valencia round orange cultivar juice;

FIG. 4D is plot of feeling factor notes sensory data and a linear analysis of such data for blends including varying levels of Vernia round orange juice with Rhode Red Valencia round orange cultivar juice;

FIG. 5A is a plot of juice Color Number for four different cultivars, showing color development during a portion of a Crop R growing season;

FIG. 5B is a plot of the ratio of Brix to citric acid content (BAR) for Crop R;

FIG. 5C is a plot of citric acid values showing acid progression for the cultivars of Crop R during the indicated growing season;

FIG. 5D is a plot of Brix values, showing the progression of Brix development during this Crop R growing season;

FIG. 6A is a plot of juice Color Number for four different cultivars, showing color development during the indicated time period of a Crop S growing season;

FIG. 6B is a plot of the ratio of Brix to citric acid content (BAR) for Crop S; and

FIG. 6C is a plot of Brix values, showing the progression of Brix development during the Crop S growing season.

### DESCRIPTION OF THE PREFERRED EMBODIMENTS

Orange juice in accordance with the present invention incorporates juice from round orange cultivars which are mid-season varieties that can be harvested during a peak properties season which is between the peak harvest season of early-to-mid season round orange cultivars and the peak harvest season of Valencia round orange cultivars. Unlike the later season Valencia round orange cultivars, however, the cultivars concerning the present invention are far superior in properties than are Valencia round oranges when harvested much earlier in the round orange growing season, that is in this mid-season time frame.

These are instrumental in providing orange juice, especially advantageously including not from concentrate orange juice, which is of enhanced value for use early in the later growing season typical of Valencia round oranges. Also advantageous is the fact that juices according to the invention exhibit flavor, color and chemical properties which are improved when compared with those provided when only Valencia round oranges are incorporated in the oranges extracted in this early portion of the traditional Valencia growing season. Accordingly, enhanced properties are imparted to the not from concentrate orange juice in accordance with the present invention without detracting from the other positive properties and characteristics of orange juice in general. When the juice is of the not from concentrate type, the result is an intermediate season not from concentrate orange juice which is improved over that currently available, which includes incorporating freshly squeezed Hamlin orange juice, other early or middle season cultivar juices or Valencia cultivar juices harvested at that time.

Intermediate season round orange cultivars which are used in the process and included in the juice according to the present invention provide juice having improved sensory attributes, enhanced chemical properties, and Color Number values which are consistently superior to these properties of other orange juice blends available at that time of the year which is late in the peak harvest season for early-to-mid season round orange cultivars and which also is early in the traditional late season for Valencia cultivars. This continues substantially throughout the peak harvest season for these mid-season round oranges. Cultivars of the invention have been found to possess each of superior sensory qualities, exceptional early season color, and greater Brix to acid ratios. These cultivars are variously referred to herein by the general terms “mid-season cultivars” or “intermediate peak season cultivars” or “very early later season cultivars.” It will be understood that these terms exclude Hamlin round orange varieties, Pineapple round orange varieties, Hughes Valencia, Rhode Red Valencia, and other Valencia round orange cultivars which do not exhibit the intermediate season properties noted herein.

With more particular reference to these very early later season cultivars, they exhibit intermediate season color which is at least as or more intense than the deepest color Valencia juice, particularly during the early harvest season for Valencia round oranges, including from the months of December, January and February. The juice from these very early maturing later season cultivars also exhibits the minimum total solids weight percentages (or minimum Brix values) which are in excess of those provided by juice from Hamlin round oranges, other early-to-late season orange cultivars, Pineapple round oranges, and other Valencia varieties.

Typically, these mid-season cultivars also exhibit superior Brix to acid ratio (BAR) development much earlier in the growing season than these other later season cultivars. To the extent that requirements of the State of Florida Department of Agriculture are at issue during this intermediate harvest time, the mid-season cultivars are able to meet the requirements at a time in the harvest season prior to that at which such standard is achieved by the Valencia round orange cultivars. It will be appreciated that Brix is a well-recognized parameter by which the quality of fruits including citrus fruits such as oranges is measured. A Brix measurement is a minimum total solids percentage by weight, which is at times loosely equated to sweetness or sugars present in the fruit. It is also generally appreciated that the acid in the Brix to acid ratio is citric acid.

As an example of the citrus fruit maturity requirements of the Florida Department of Agriculture and Consumer Services, orange standards of this agency for a particular recent growing season were as follows. For oranges harvested between August 1 and October 31, the minimum total solids are permitted vary between 9.0. degree. Brix and below 11.0. degree. Brix. Furthermore, these State of Florida specifications specify that a corresponding minimum BAR must be met for each Brix value within this range. Different standards apply for different stages of the year. For example, for oranges harvested between December 1 and July 31, the minimum total solids are permitted to vary between 8.0 Brix and 8.5 Brix. These State of Florida specifications specify a corresponding minimum BAR which varies between 10.50 and 10.30 during these later harvest season months. More particularly, the standards referred to herein are in accordance with the following Table I.

TABLE I
ROUND ORANGE MATURITY CHART

| | |
|---|---|
| Brix | BAR |

August 1-October 31

| | |
|---|---|
| 9.0 to not including 9.1 | 10.00 to 1 |
| 9.1 to not including 9.2 | 9.95 to 1 |
| 9.2 to not including 9.3 | 9.90 to 1 |
| 9.3 to not including 9.4 | 9.85 to 1 |
| 9.4 to not including 9.5 | 9.80 to 1 |
| 9.5 to not including 9.6 | 9.75 to 1 |
| 9.6 to not including 9.7 | 9.70 to 1 |
| 9.7 to not including 98 | 9.65 to 1 |
| 9.8 to not including 9.9 | 9.60 to 1 |
| 9.9 to not including 10.0 | 9.55 to 1 |
| 10.0 to not including 10.1 | 9.50 to 1 |
| 10.1 to not including 10.2 | 9.45 to 1 |
| 10.2 to not including 10.3 | 9.40 to 1 |
| 10.3 to not including 10.4 | 9.35 to 1 |
| 10.4 to not including 10.5 | 9.30 to 1 |
| 10.5 to not including 10.6 | 9.25 to 1 |
| 10.6 to not including 10.7 | 9.20 to 1 |
| 10.7 to not including 10.8 | 9.15 to 1 |
| 10.8 to not including 10.9 | 9.10 to 1 |
| 10.9 to not including 11.0 | 9.05 to 1 |

November 1-November 15

| | |
|---|---|
| 8.7 to not including 8.8 | 10.15 to 1 |
| 8.8 to not including 8.9 | 10.10 to 1 |
| 8.9 to not including 9.0 | 10.05 to 1 |

November 16-November 30

| | |
|---|---|
| 8.5 to not including 8.6 | 10.25 to 1 |
| 8.6 to not including 8.7 | 10.20 to 1 |

December 1-July 31

| | |
|---|---|
| 8.0 to not including 8.1 | 10.50 to 1 |
| 8.1 to not including 8.2 | 10.45 to 1 |
| 8.2 to not including 8.3 | 10.40 to 1 |
| 8.3 to not including 8.4 | 10.35 to 1 |
| 8.4 to not including 8.5 | 10.30 to 1 |

The mid-season cultivars meet or exceed the round orange standards as noted in Table I during their peak harvesting months of December, January and February, typically at a date earlier than they are met by Valencia round oranges which are the standard ideal cultivars of the citrus industry in terms of their properties which are understood by the consuming public to be the preferred juice.

These very unique mid-season cultivars primarily comprise Vernia round orange cultivars. Somewhat less desirable are Frost cultivars, also characterized as a mid-season cultivar, but not as beneficial as the Vernia round oranges.

It will be appreciated that large-scale commercial production of not from concentrate orange juice typically includes a blend operation. For example, in the fall of the year in the Northern Hemisphere, stored juice supplies are blended with early season fresh juice in order to provide the not from concentrate orange juice which is filled into cartons for distribution and consumption by the consumer. Typically, in the early months of the fresh juice harvest season, this fresh juice supply is from Hamlin round oranges. Hamlin round oranges have a peak harvest season between about early November and early January. Similarly, the late season Valencia cultivars have a significantly later peak harvest season, namely from about late February through late April. The Valencia cultivars also exhibit relatively high Color Numbers during their peak harvest season. Typically, the maximum Color Numbers achieved by the mid-season cultivars during their peak harvest season are comparable or higher than the maximum Color Numbers achieved by these Valencia oranges during the same respective time periods. Clearly, the mid-season cultivars Color Numbers are higher than those of Hamlin round oranges, even during their own peak harvest season. For example, during this time frame, the juice from Hamlin round oranges has a peak color number of about 32 CN. The mid-season cultivars have a higher color number, typically at least 35 CN and above at the intermediate harvest season which is a characteristic of the mid-season cultivar juices. Often, this color number value is at least 36 CN.

Within the context of commercial production of not from concentrate orange juice during this intermediate season time frame, a typical target Color Number for the in-carton not from concentrate orange juice is at least 36 CN. It will be appreciated that, because such production is dependent upon naturally occurring whole juice sources which have not been concentrated, this target is not always strictly met and at times can be between 35 CN to about 37 CN, especially within this intermediate season time frame. It will be further appreciated that the freshly squeezed juice, especially within this intermediate season time frame, can be blended with stored juice, such as that which has been held at a relatively low temperature as whole juice or otherwise safely stored as whole juice for blending use during this time frame.

In a production within which Hamlin juice sources having a maximum Color Number of 32 CN are used as a fresh juice component together with fresh Valencia juice early in its season in making an intermediate season not from concentrate whole juice blend, a greater proportion of Valencia juice is required than when the Vernia mid-season fresh juice component is included in the blend, if the target Color Number is to be achieved by the not from concentrate blend.

Advantageously, the higher intermediate season Color Number values when compared with at least Hamlin juices which are characteristic of the mid-season cultivars of the invention will permit either a larger relative percentage of fresh juice or a cartoned product having a higher Color Number than otherwise obtainable when other juices are used which are harvested during this intermediate time frame. Accordingly, in one aspect of the invention, the mid-season cultivar juice can be blended with Hamlin juice sources, and/or with other early-to-late season round orange cultivar juices in order to provide an intermediate season fresh whole juice source which has an increased Color Number. Alternatively, the mid-season cultivars can be the sole source of the fresh juice going into the cartoned blend.

Importantly, uses of the very early later season cultivars in preparing not from concentrate orange juice products is made even more advantageous because of other, very important properties of these very early later season cultivars. These very early later season round orange cultivars achieve a BAR level which exceeds that of even the most widely used and accepted of Valencia juices, including Hughes and Rhode Red Valencia juices, at least when harvested during the same time frame. This facilitates the ability of the fresh juice to meet and fully satisfy consumer and other industry standards for not from concentrate orange juice containing products.

Additionally, juices prepared from the very early later season cultivars exhibit sensory evaluation results which are in most respects detectably superior to those of even the standard of the industry Hughes and Rhode Red Valencia juices which are.harvested during this intermediate season. The sensory superiority of the very early later season cultivars is illustrated when their juices are blended with Valencia or Pineapple round orange juices. Blends at many various levels are possible. Practically, blends having between about 5 and about 70 volume percent of the mid-season juice of the total volume of the blended juice product will be practiced, typically between about 10 and about 60 volume percent. Ideal volume ratios will vary somewhat for different juice blends.

Objective sensory qualities are expressed in terms of several specific sensory characteristics which are identifiable by trained sensory panels. Surprisingly, descriptive sensory analyses have shown that addition of the mid-season cultivars made favorable quality improvements to the generally accepted superior sensory attributes of widely used Valencia round orange juices. Overall trends in this regard include reduced green character, bitterness, sour, other citrus, feeling factors and packaged notes, as well as trends toward increased raw and total orange flavors and increased sweetness.

Exemplary illustrations of the disclosure herein are provided in the following examples.

### EXAMPLE 1

Polynomial trends lines for various round orange cultivar juices are plotted in FIG. 1. These trend lines are based on “overall quality” performance of juices from three categories of cultivars. Each trend line shows the variation in overall quality sensory panel scores during a growing season. The peak scores are generally evident, and the central portion of each curve represents the harvesting season for each category of cultivar. For the early-to-mid-season cultivars, including Hamlin, Pineapple, and other cultivars in this harvesting category, the harvest season runs between early October and early March, with the peak season of overall quality occurring between about mid-November and early January. For the Valencia varieties, primarily Hughes and Rhode Red Valencia cultivars, the harvesting season is shown between late December and late May, with the peak of sensory overall quality results occurring from about early February to early April. For the Vernia juice, the harvesting season is shown between late October and mid March, with the peak harvesting season being between early December and early February.

These data concisely illustrate the gap-filing characteristics achieved by the invention. The Vernia cultivar's peak properties are provided just as the early/mid cultivars are decreasing in overall quality and while the Valencia cultivars still only are increasing in overall quality. The best Vernia overall quality score occurred on January 30, the rating being −0.5. This was higher than the overall quality shown at any time along the other two polynomial trend lines.

### EXAMPLE 2

Pieces of round orange fruit harvested in December and January in the northern hemisphere were used in making base juices and whole juice blends. These are identified as Crop Q fruit. Juice quality analyses for each of the four base juices and juice blends for fruit harvested on December 20 are reported in Table II.

TABLE II
(CROP Q)

| CULTIVARS | VOL % | BRIX | ACID | BAR | COLOR | VIT C |
|---|---|---|---|---|---|---|
| VERNIA | 100% | 10.09 | 0.84 | 12.13 | 37.97 | 39.22 |
| PINEAPPLE | 100% | 9.89 | 0.83 | 11.91 | 36.23 | 40.27 |
| HUGHES | 100% | 9.51 | 1.34 | 7.10 | 36.40 | 41.50 |
| ROHDE RED | 100% | 9.85 | 1.34 | 7.35 | 37.77 | 42.87 |
| VERNIA/ | 10% | 9.90 | 0.93 | 10.65 | 36.7 | 41.52 |
| PINEAPPLE | 30% | 10.24 | 1.39 | 7.37 | 37.0 | 40.30 |
| | 60% | 10.01 | 0.98 | 10.21 | 37.6 | 41.39 |
| VERNIA/ | 10% | 9.59 | 0.95 | 10.09 | 36.6 | 40.70 |
| HUGHES VAL | 30% | 9.63 | 0.71 | 13.56 | 36.9 | 40.41 |
| | 60% | 9.79 | 0.67 | 14.61 | 37.3 | 40.19 |
| VERNIA/ | 10% | 9.72 | 0.89 | 10.92 | 38.0 | 41.88 |
| ROHDE RED | 30% | 9.88 | 1.15 | 8.59 | 38.1 | 41.51 |
| | 60% | 9.92 | 1.19 | 8.34 | 38.1 | 40.73 |

Fruit of each of these cultivars having a January 19 harvest date were subjected to juice quality analysis. The Brix values were as follows: Vernia, 10.58°; Pineapple, 11.03°; Hughes Valencia, 10.22°; and Rohde Red Valencia, 10.98°. The acid analysis values were as follows: Vernia, 0.75; Pineapple, 0.83; Hughes Valencia, 1.31; and Rohde Red Valencia, 1.29. The resulting BAR values were: Vernia, 14.11; Pineapple, 13.29; Hughes Valencia, 7.80; and Rohde Red Valencia, 8.51. The color values were as follows: Vernia, 39.60; Pineapple, 37.70; Hughes Valencia, 37.30; and Rohde Red Valencia, 38.90. The vitamin C values were: Vernia, 37.94; Pineapple, 45.51; Hughes Valencia, 38.9; and Rohde Red Valencia, 41.82.

### EXAMPLE 3

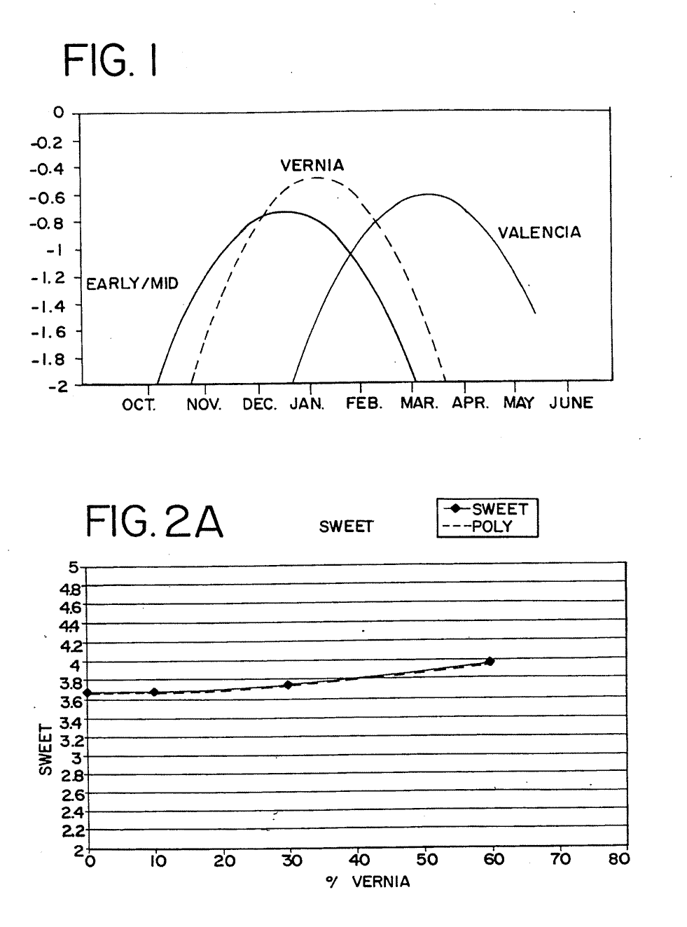

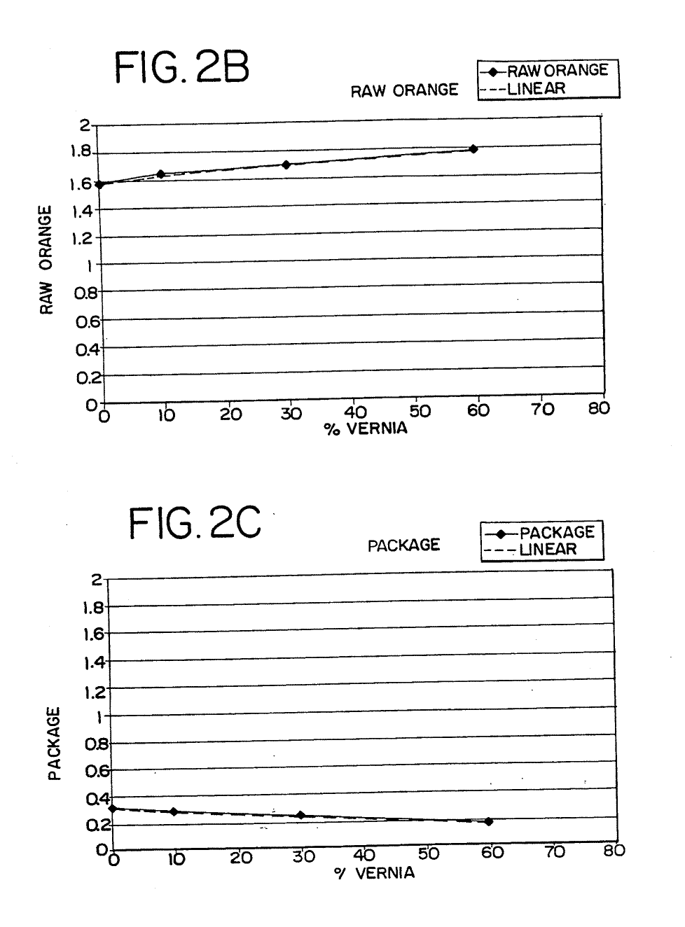

Juice quality analyses for the blends shown in Table II were conducted for varying levels of the Vernia juice blended with the Pineapple cultivar juice. The blends were no Vernia juice, 10 volume percent Vernia juice, 30 volume percent Vernia juice and 60 volume percent Vernia juice. Sweetness data are plotted in FIG. 2A. The numerical value on the sweetness scale was 3.7 for the first three blends. For the blend containing 60% Vernia, the sweetness value was 4.0, leading to the conclusion that the addition of at least 60% Vemia juice significantly increased sweetness when compared with the 100% pineapple juice. The P-value was 0.01.

Another sensory quality evaluated by the sensory panel using the descriptive sensory analysis was raw orange, the results being shown in FIG. 2B. This sensory quality increased from 1.6 for the pineapple cultivar juice having no Vernia juice to 1.8 for the whole juice blend having 60% Vernia juice. For the package flavor note, a decrease was observed from 0.3 for the no Vernia, 10% Vernia and 30% Vernia blends and 0.2 for the blend of 60% Vernia juice and 40% Pineapple round orange juice.

### EXAMPLE 4

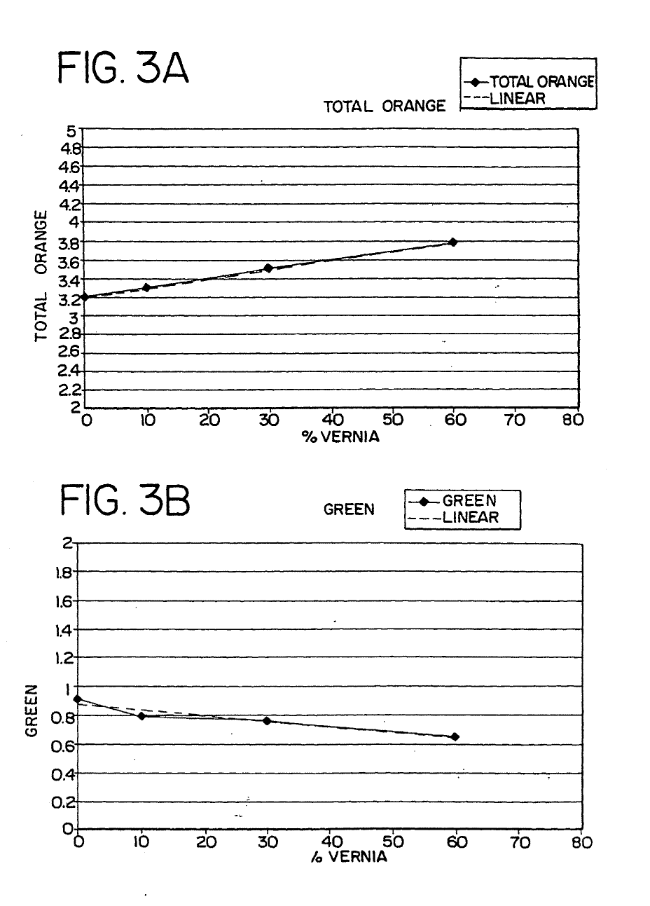

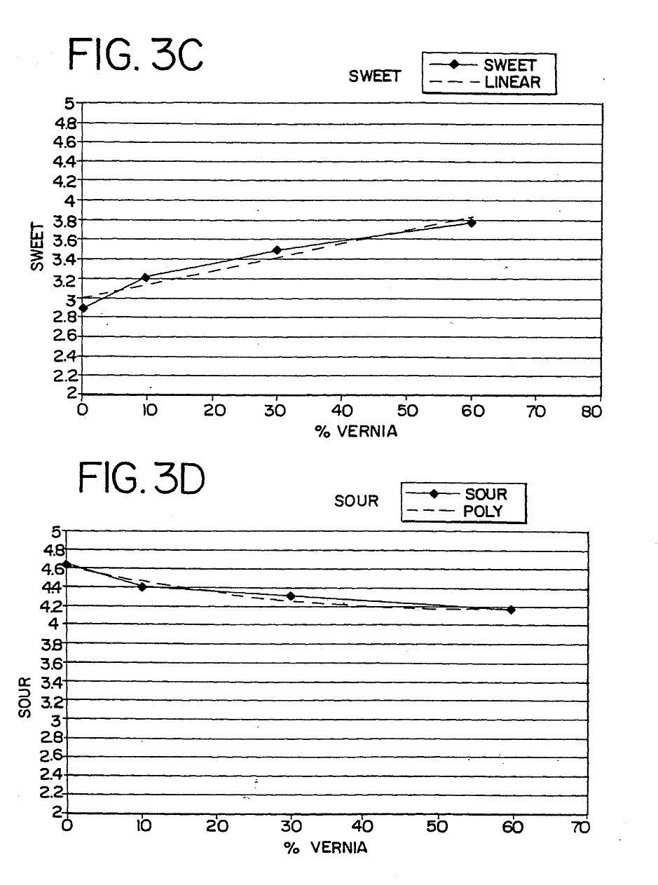

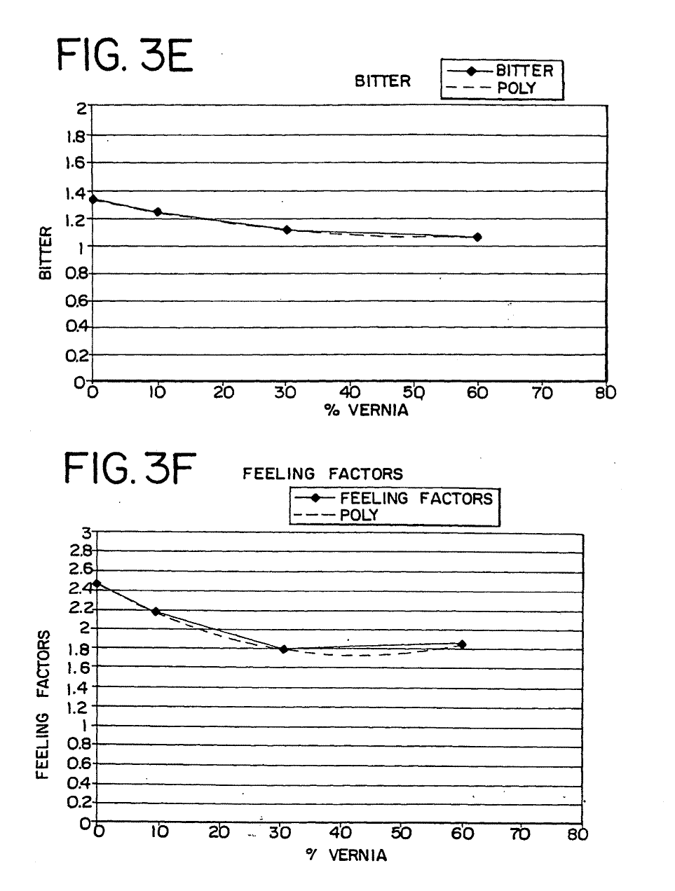

The blends of Hughes Valencia and Vernia juices which are specified in Example 2 were evaluated by the sensory panel using the descriptive sensory analysis. Each blend was compared with 100% Hughes Valencia juice as the control. With increasing percentages of Vernia juice added to Hughes Valencia, the total orange and sweetness sensory values increased, reported in FIG. 3A and FIG. 3C, respectively, while green character and sourness decreased, reported in FIGS. 3B and 3D, respectively. Both bitterness and feeling factors sensory qualities decreased with increasing percentages of Vernia juice, with the effect being greater at the 30% level when compared with the change from the 30% level to the 60% level. These results are reported in FIG. 3E and FIG. 3F. In addition, raw orange character was highest with 30% and 60% Vernia in the blend, while chemical notes were lowest at these levels. The raw orange values were 0.9 for 100% Huges Valencia juice, 0.9 for the blend having 10% Vernia juice, 1.4 for the blend containing a 30% Vernia juice, and 1.3 for the blend containing 60% Vernia juice. The chemical notes sensory data showed a value of 1.2 for the base Huges Valencia juice, 1.3 for the blend containing 10% vernia juice, and 0.9 for each of the blends of 30% and 60% Vernia juice. These indicated differences were statistically significant. At the 60% Vernia level, the other fruit flavor note and the perfumy floral note were significantly higher, and the other citrus note was significantly lower than the 100% Huges Valencia control juice.

### EXAMPLE 5

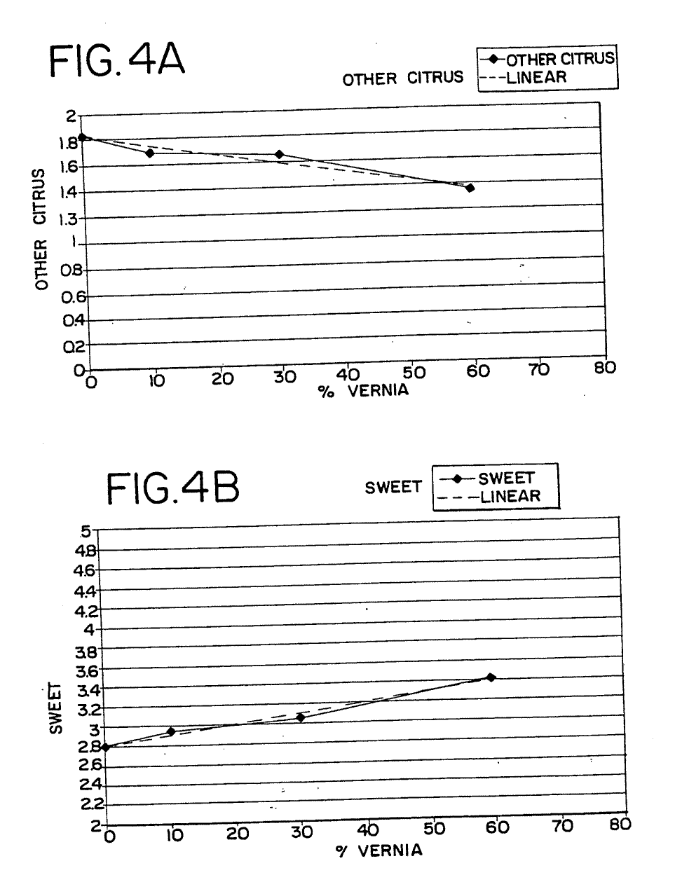

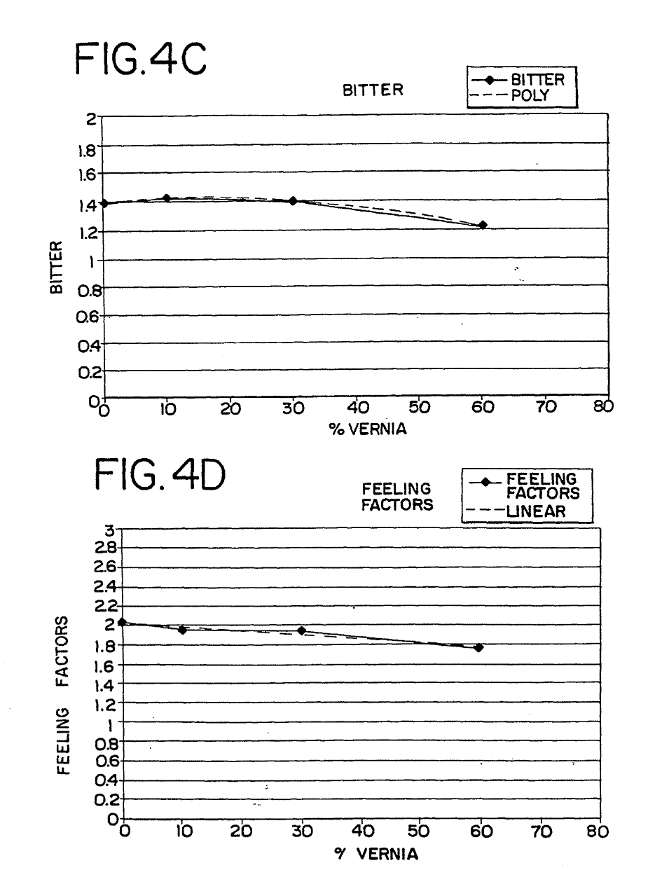

The blends of Rhode Red Valencia juices and Vernia juices which are specified in Example 2 were evaluated by the sensory panel using the descriptive sensory panel using the descriptive analysis. Each blend was prepared with 10% Rhode Red Valencia as the control. The other citrus flavor notes and the feeling factors notes decreased with increasing Vernia juice within the blends, while sweetness increased. See FIG. 4A, FIG. 4D and FIG. 4B, respectively. Bitterness notes showed a significant decrease with the 60% Vernia blend, reported in FIG. 4C. The sour notes also were significantly deceased with 60% Vernia in the blend, falling from 4.0 to 3.8.

### EXAMPLE 6

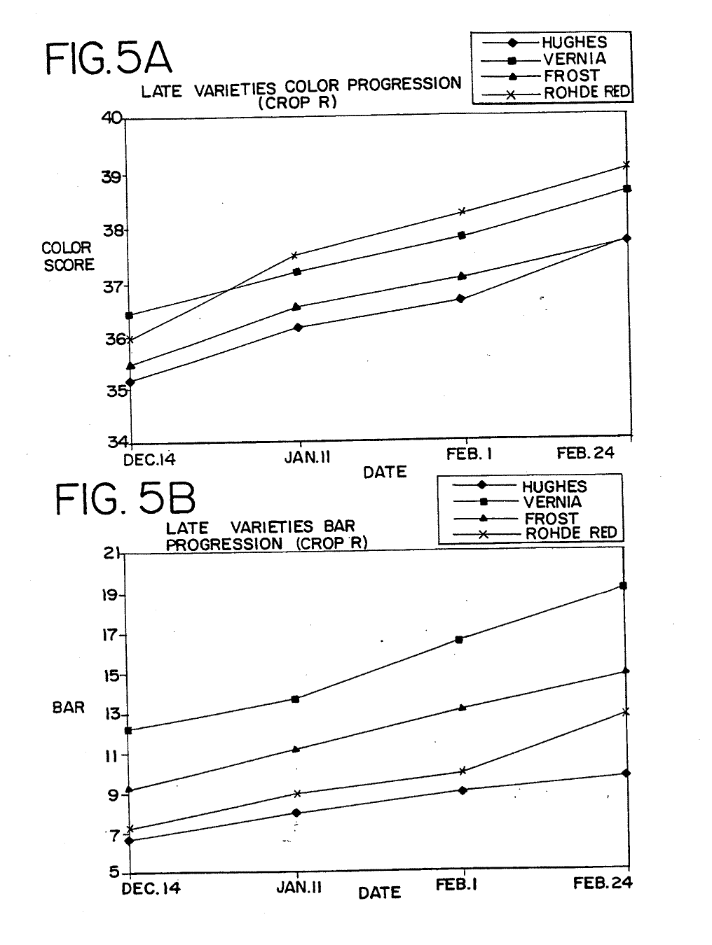

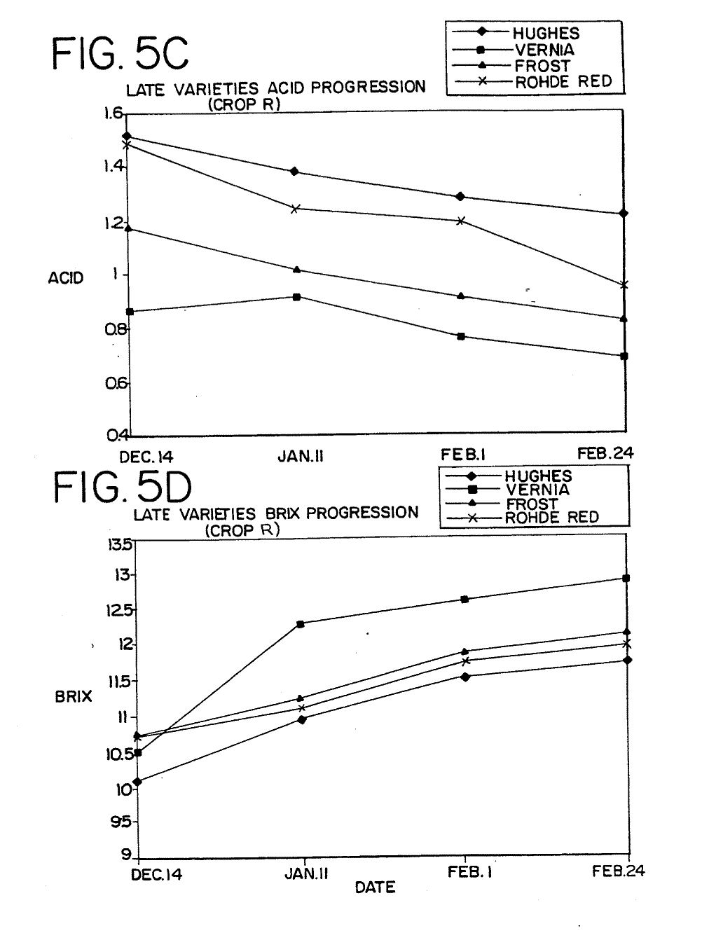

Pieces of fruit harvested from mid-December to mid-March of the following year in the northern hemisphere were used in making juices. These are identified as juices from Crop R fruit. Juice quality analyses for each of the four base juices are reported in FIG. 5A, FIG. 5B, FIG. 5C, and FIG. 5D, as well as Table III.

TABLE III
(CROP R)

| CULTIVAR | DATE | BRIX | ACID | BAR | COLOR |
|---|---|---|---|---|---|
| HUGHES | 12/14 | 10.10 | 1.51 | 6.70 | 35.17 |
| | 1/11 | 10.97 | 1.38 | 7.97 | 36.13 |
| | 2/1 | 11.53 | 1.28 | 8.99 | 36.60 |
| | 2/24 | 11.73 | 1.21 | 9.72 | 37.67 |
| | 3/16 | 12.20 | 1.11 | 10.99 | 37.83 |
| VERNIA | 12/14 | 10.50 | 0.86 | 12.20 | 36.43 |
| | 1/11 | 12.28 | 0.91 | 13.70 | 37.13 |
| | 2/1 | 12.61 | 0.76 | 16.56 | 37.77 |
| | 2/24 | 12.88 | 0.68 | 19.12 | 38.57 |
| | 3/16 | 12.35 | 0.66 | 18.64 | 38.83 |
| FROST | 12/14 | 10.74 | 1.17 | 9.25 | 35.47 |
| | 1/11 | 11.24 | 1.01 | 11.16 | 36.50 |
| | Feb. 1, 1999 | 11.88 | 0.91 | 13.09 | 37.03 |
| | 2/24 | 12.12 | 0.82 | 14.82 | 37.67 |
| | 3/16 | 12.37 | 0.84 | 14.69 | 37.97 |
| ROHDE RED | 12/14 | 10.71 | 1.48 | 7.26 | 35.93 |
| | 1/11 | 11.11 | 1.24 | 8.95 | 37.47 |
| | 2/1 | 11.75 | 1.19 | 9.90 | 38.20 |
| | 2/24 | 11.97 | 0.94 | 12.71 | 39.00 |
| | 3/16 | 12.56 | 1.09 | 11.54 | 39.50 |

### EXAMPLE 7

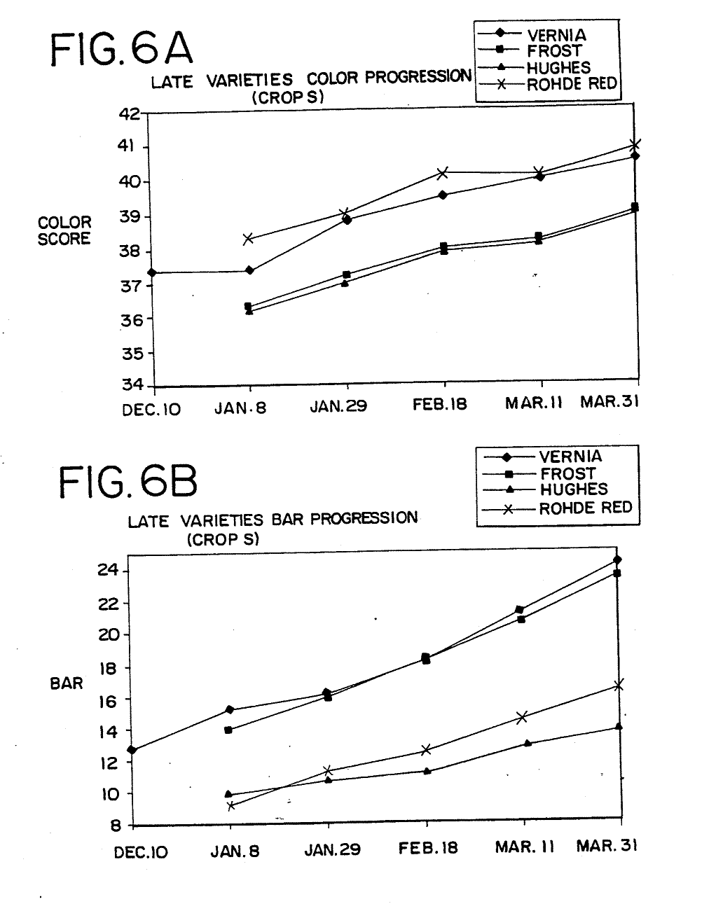

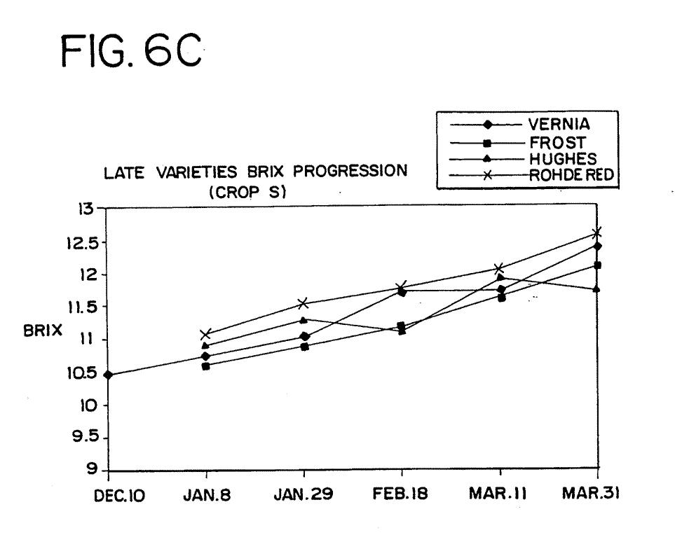

Pieces of fruit harvested from mid-December to late March in the northern hemisphere were used in making base juices from each of Vernia cultivar fruit, Frost cultivar fruit, Hughes Valencia cultivar fruit and Rhode Red Valencia cultivar fruit. These are identified as CROP S fruit. Juice quality analyses for each of these juices are reported in FIG. 6A, FIG. 6B and FIG. 6C, as well as in Table IV.

TABLE IV
(CROP S)

| CULTIVAR | DATE | BRIX | ACID | BAR | COLOR |
|---|---|---|---|---|---|
| VERNIA | 12/10 | 10.47 | 0.82 | 12.76 | 37.37 |
| | 1/8 | 10.74 | 0.71 | 15.20 | 37.37 |
| | 1/29 | 11.04 | 0.69 | 16.13 | 38.80 |
| | 2/18 | 11.73 | 0.65 | 18.15 | 39.47 |
| | 3/11 | 11.74 | 0.55 | 21.23 | 40.00 |
| | 3/31 | 12.40 | 0.51 | 24.24 | 40.53 |
| FROST | 1/8 | 10.59 | 0.76 | 13.96 | 36.30 |
| | 1/29 | 10.90 | 0.69 | 15.91 | 37.23 |
| | 2/18 | 11.19 | 0.62 | 18.22 | 38.03 |
| | 3/11 | 11.65 | 0.57 | 20.57 | 38.23 |
| | 3/31 | 12.10 | 0.52 | 23.49 | 39.03 |
| HUGHES | 1/8 | 10.96 | 1.12 | 9.79 | 36.17 |
| | 1/29 | 11.31 | 1.03 | 11.01 | 37.00 |
| | 2/18 | 11.17 | 1.01 | 11.10 | 38.00 |
| | 3/11 | 11.88 | 0.93 | 12.86 | 38.27 |
| | 3/31 | 11.77 | 0.85 | 13.81 | 39.00 |
| ROHDE RED | 1/8 | 11.08 | 1.21 | 9.19 | 38.30 |
| | 1/29 | 11.54 | 1.03 | 11.26 | 38.97 |
| | 2/18 | 11.75 | 0.95 | 12.44 | 40.13 |
| | 3/11 | 12.04 | 0.84 | 14.41 | 40.10 |
| | 3/31 | 12.59 | 0.77 | 16.36 | 40.87 |

It will be understood that the embodiments of the present invention which have been described are illustrative of some of the applications of the principles of the present invention. Numerous modifications may be made by those skilled in the art without departing from the true spirit and scope of the invention.

What is claimed is:

1. A method of commercially producing a not from concentrate orange juice product, comprising:
harvesting a mid-season round orange cultivar selected from the group consisting of a Vernia cultivar, a Frost cultivar, or a combination of these mid-season cultivars, said harvesting providing said mid-season orange cultivar which has its peak properties during a mid-season time period, said mid-season time period being after the peak harvesting season for early-to-mid season round orange fruit, namely Hamlin orange fruit, and before the peak harvesting season for late season round orange fruit, namely Hughes Valencia and Rhode Red Valencia orange fruit, each said peak harvesting season being within the growing territory of the mid-season cultivar;
extracting juice from a volume of said mid-season round oranges;
collecting the resulting extracted orange juice as a mid-season orange juice having a Brix-to-acid ratio (BAR) during said harvesting step which is greater than that of either early-to-mid season round orange fruit or late season round orange fruit harvested during said mid-season period; and
blending, on a commercial scale, said collected mid-season orange juice with another orange juice source which is not harvested during said mid-season time period and providing a not from concentrate juice composition therefrom having a BAR value and sensory qualities superior to the BAR value and the sensory qualities, respectively, of not from concentrate orange juice of either said earlier season round orange fruit juice or said late season orange fruit harvested during said mid-season harvesting time period.

2. The method of claim 1, wherein said harvesting occurs in December to February in the northern hemisphere.

3. The method of claim 1, wherein said collecting step provides mid-season orange juice having a Color Number of at least 1 CN greater than Hamlin orange juice harvested at the time of said harvesting step.

4. The method of claim 1, wherein said collecting step provides mid-season orange juice having a Color Number of at least 2 CN greater than Hamlin orange juice harvested at the time of said harvesting step.

5. The method of claim 1, wherein said harvesting step harvests Vernia cultivars, and said collecting step provides mid-season orange juice having a Color Number of at least 1 CN greater than Hughes Valencia orange juice harvested at the time of said harvesting step.

6. The method of claim 1, wherein said collecting step provides a juice having a Brix-to-acid ratio (BAR) during the months of December to February in the northern hemisphere which meets or exceeds the Orange Fruit Maturity Standards of the Florida Department of Agriculture & Consumer Services.

7. The method of claim 1, wherein said collecting step provides a juice having an acid value which is less than the acid value of juice harvested from said late season round orange fruit during the months of December to February in the northern hemisphere.

8. A commercially produced not from concentrate orange juice product made by a method comprising:
harvesting a mid-season round orange cultivar selected from the group consisting of a Vernia cultivar, a Frost cultivar, or a combination of these mid-season cultivars, said harvesting providing said mid-season orange cultivar which has its peak properties during a mid-season time period, said mid-season time period being after the peak harvesting season for earlier season round orange fruit, namely Hamlin orange fruit, and before the peak harvesting season for late season round orange fruit, namely Hughes Valencia and Rhode Red Valencia orange fruit, each said peak harvesting season being within the growing territory of the mid-season cultivar;
extracting juice from a volume of said mid-season round oranges;
collecting the resulting extracted orange juice and providing a not from concentrate mid-season orange juice having a Color Number of at least 36 CN units and having a Brix-to-acid ratio (BAR) during said harvesting which is greater than that of either said earlier season round orange fruit or said late season round orange fruit harvested during said mid-season time period;
blending, on a commercial scale, said not from concentrate mid-season orange juice with another orange juice source in order to provide a not from concentrate juice composition having sensory qualities equivalent or superior to the sensory qualities of not from concentrate orange juice made from either said earlier season round orange fruit juice or said late season round orange fruit harvested during said mid-season harvesting time period; and
said not from concentrate juice composition has at least about 5 volume percent, based on the volume of the orange juice, of said not from concentrate mid-season orange juice.

9. The product of claim 8, wherein said earlier season juice or late season juice harvested during said mid-season time period is said another orange juice source.

10. The product of claim 8, wherein said another orange juice source is stored orange juice.

11. The product of claim 8, wherein said not from concentrate juice composition includes up to about 80 volume percent of said not from concentrate mid-season orange juice.

12. The product of claim 8, wherein said not from concentrate orange juice product has overall quality sensory scores greater than those of Hamlin, Hughes Valencia or Rhode Red Valencia not from concentrate juices from orange fruit harvested during said mid-season time period.

13. The product of claim 8, wherein not from concentrate orange juice product has a sensory green character which is less than that of Hughes Valencia or Rhode Red Valencia not from concentrate orange juice harvested during said mid-season time period.

14. The product of claim 8, wherein said not from concentrate orange juice product has a sensory bitterness character which is less than that of Hughes Valencia or Rhode Red Valencia not from concentrate orange juice harvested during said mid-season time period.

15. The product of claim 8, wherein said not from concentrate orange juice product has a sensory feeling factors character which is less than that of Hughes Valencia or Rhode Red Valencia not from concentrate orange juice harvested during said mid-season time period.

16. The product of claim 8, wherein said not from concentrate orange juice product has a sensory sourness character which is less than that of Hughes Valencia not from concentrate orange juice harvested during said mid-season time period.

17. The product of claim 8, wherein said not from concentrate orange juice product has a sensory other citrus notes character which is less than that of Rhode Red Valencia not from concentrate orange juice harvested during said mid-season time period.

18. The product of claim 8, wherein said not from concentrate orange juice product has a sensory packaged notes character which is less than that of Pineapple cultivar not from concentrate orange juice harvested during said mid-season time period.

19. The product of claim 8, wherein said not from concentrate orange juice product has a sensory total orange character which is greater than that of Hughes Valencia not from concentrate orange juice harvested during said mid-season time period.

20. The product of claim 8, wherein said not from concentrate orange juice product has a sensory raw orange character which is greater than that of Pineapple cultivar not from concentrate orange juice harvested during said mid-season time period.

21. The product of claim 8, wherein said not from concentrate orange juice product has a sensory sweet character which is greater than that of Hughes Valencia, Rhode Red Valencia or Pineapple cultivar not from concentrate orange juice harvested during said mid-season time period.

22. A method of commercially producing a not from concentrate orange juice product, comprising:
harvesting Vernia cultivar round oranges which have their peak properties during a mid-season time period, said mid-season time period being after the peak harvesting season for an earlier season round orange fruit, namely Hamlin orange fruit, and before the peak harvesting season for late season round orange fruit, namely Hughes Valencia and Rhode Red Valencia orange fruit, each said peak harvesting season being within the growing territory of the Valencia oranges;
extracting juice from a volume of said Vernia round oranges;
collecting the resulting extracted orange juice as a mid-season orange juice having a Brix-to-acid ratio (BAR) during said harvesting step which is greater than that of either said earlier season round orange fruit or said late season round orange fruit harvested during said mid-season time period; and
blending, on a commercial scale, said collected mid-season orange juice with another orange juice source and providing a not from concentrate juice composition having a BAR value and sensory qualities superior to the BAR value and sensory qualities, respectively, of not from concentrate orange juice from either said earlier season round orange fruit juice or said late season round orange fruit harvested during said mid-season time period.

23. The method of claim 22, wherein said blending step incorporates up to about 80 volume percent of said extracted orange juice.

24. The method of claim 22, wherein said blending step provides mid-season orange juice having overall quality sensory scores greater than those of Hamlin, Hughes Valencia or Rhode Red Valencia juices from orange fruit harvested at the time of said harvesting step.

25. A commercially produced not from concentrate orange juice product made by a method comprising:
harvesting Vernia cultivar round oranges which have their peak properties during a mid-season time period, said mid-season time period being after the peak harvesting season for Hamlin round orange fruit and being before the peak harvesting season for late season round orange fruit, namely Hughes Valencia and Rhode Red Valencia orange fruit, each said peak harvesting season being within the growing territory of the Vernia orange;
extracting juice from a volume of said Vernia round oranges;
collecting the resulting extracted orange juice and providing a mid-season orange juice having a Color Number of at least 36 CN units and having a Brix-to-acid ration (BAR) during said harvesting which is greater than that of either said Hamlin round orange fruit or said late season round orange fruit harvested during said mid-season time period;
blending, on a commercial scale, said collected mid-season orange juice with another orange juice source in order to provide a juice composition have a BAR value and sensory qualities superior to the BAR value and the sensory qualities, respectively, of not from concentrate orange juice from either said Hamlin round orange fruit or said late season round orange fruit harvested during said mid-season time period; and
said not from concentrate juice composition has at least about 5 volume percent, based on the volume of the orange juice, of said not from concentrate Vernia juice.

26. A not from concentrate orange juice composition comprising:
a blend of up to about 99 volume percent of a mid-season orange juice supply, based upon the total volume of the composition, said mid-season juice supply being a not from concentrate orange juice, and at least about 1 percent by volume of an orange juice supply other than said mid-season orange juice supply, based upon the total volume of the composition;
said fruit from which the not from concentrate mid-season orange juice originates is a round orange cultivar selected from Vernia cultivars, Frost cultivars, or a combination of these mid-season cultivars, said mid-season cultivars had been harvested and made into said not from concentrate juice during a mid-season time period, said mid-season time period being after peak harvesting season for Hamlin orange fruit and before peak harvesting season for Hughes Valencia and Rhode Red Valencia orange fruit; and
said mid-season orange juice has a sensory profile superior to that of 100 percent Hughes Valencia or Rhode Red Valencia orange juice from fruit harvested during said mid-season time period.

27. The composition of claim 26, wherein said mid-season juice comprises up to about 80 percent by volume of the composition, based upon the total volume of the composition.

28. The composition of claim 26, wherein said mid-season cultivar is a Vernia round orange cultivar.

29. The composition of claim 26, wherein said not from concentrate orange juice product has overall quality sensory scores greater than those Hamlin, Hughes Valencia or Rhode Red Valencia not from concentrate juices from orange fruit harvested during mid-season time period.
